(19) United States
(12) Patent Application Publication
(10) Pub. No.: US 2022/0089895 A1
(43) Pub. Date: Mar. 24, 2022

(54) CONDUCTIVE INK COMPOSITIONS

(71) Applicant: XTPL S.A., Wroclaw (PL)

(72) Inventors: Mateusz LYSIEN, Wroclaw (PL); Maciej ZlEBA, Wroclaw (PL); Aneta WIATROWSKA, Wroclaw (PL); Filip GRANEK, Wroclaw (PL)

(73) Assignee: XTPL S.A., Wroclaw (PL)

(21) Appl. No.: 17/425,660

(22) PCT Filed: Mar. 20, 2019
(86) PCT No.: PCT/IB2019/052288

§ 371 Date: Jul. 23, 2021

(30) Foreign Application Priority Data
Feb. 19, 2019 (PL) PL428963

(51) Int. Cl. C09D 11/52; C09D 11/033; C09D 11/037; C08K 3/08; C08K 9/08; C08K 5/053

(52) U.S. Cl. CPC C09D 11/52; C09D 11/033; C09D 11/037; C08K 3/08; C08K 2201/011; C08K 5/053; C08K 2003/0806; C08K 2201/001; C08K 2201/005; C08K 9/08

(57) ABSTRACT

A conductive ink composition includes metallic nanoparticles, a first non-aqueous polar protic solvent, and a second non-aqueous polar protic solvent. The metallic nanoparticles can be silver nanoparticles. The silver nanoparticles can have an average particle size in a range of 20 nm to 80 nm. Polyvinylpyrrolidone is present on the metallic nanoparticle surfaces. The first solvent has a boiling point of at least 110° C. and a viscosity of at least 10 cP at 25° C. The second solvent has a boiling point of at least 200° C. and a viscosity of at least 100 cP at 25° C. The conductive ink composition contains the metallic nanoparticles in a range of 10 wt %to 75 wt %. The concentration of the second solvent in the conductive ink composition is 11.0% by volume or greater.

### BACKGROUND

Metal lines can be formed by photolithographic patterning of a photoresist layer followed by etching of an underlying metal layer using the patterned photoresist as a mask. However, because of the high cost of photolithography and etch equipment, there is a need for highly productive alternatives, particularly for line widths in the range of about 1 μm to about 10 μm.

Thermal ink jet printing is an additive process that involves vaporization of a small amount of aqueous ink and the expulsion of that ink though a nozzle onto a printable surface of a substrate. In contrast to photolithography and etch, which is a subtractive process, there is less wasted material. Metallic nanoparticle ink compositions have been developed for use in such processes. Nevertheless, it has been found that these conventional ink jet printing processes are not optimal for forming patterns with line widths in the range of about 1 μm to about 10 μm. Improved metallic nanoparticle ink compositions are desired.

### SUMMARY

In one aspect, a conductive ink composition includes metallic nanoparticles, a first non-aqueous polar protic solvent, and a second non-aqueous polar protic solvent. Polyvinylpyrrolidone is present on the metallic nanoparticle surfaces. The first solvent has a boiling point of at least 110° C. and a viscosity of at least 10 cP at 25° C. The second solvent has a boiling point of at least 200° C. and a viscosity of at least 100 cP at 25° C. The conductive ink composition contains the metallic nanoparticles in a range of 10 wt % to 75 wt %. The concentration of the second solvent in the conductive ink composition is 11.0% by volume or greater.

In another aspect, the conductive ink composition is used in a fluid printing apparatus to form a conductive feature on a substrate. The fluid printing apparatus includes a substrate stage, a print head, a pneumatic system, and a print head positioning system. The conductive ink composition can be contained in the print head. Alternatively, the pneumatic system is coupled to the print head via a fluid reservoir, and the conductive ink composition is contained in the fluid reservoir.

The above summary is not intended to describe each disclosed embodiment or every implementation of the claimed subject matter. The description that follows more particularly exemplifies illustrative embodiments. In several places throughout the application, guidance is provided through examples, which examples can be used in various combinations. In each instance of a list, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings, in which:

FIG. 1 is a flow diagram of a process of forming a printed conductive feature on a substrate.

FIG. 2 is a block diagram view of an illustrative fluid printing apparatus.

FIG. 3 is a schematic side view of a capillary glass tube.

FIG. 4 is a scanning electron microscope (SEM) view of a portion of a capillary glass tube.

FIG. 5 is a scanning electron microscope (SEM) view of a tapering portion of the capillary glass tube, under low magnification.

FIG. 6 is a scanning electron microscope (SEM) view of a tapering portion of the capillary glass tube, under high magnification.

FIG. 7 is a scanning electron microscope (SEM) view of the output portion after focused-ion beam treatment, under high magnification.

FIG. 8 is a flow diagram of a method of forming a micro-structural fluid ejector.

FIG. 9 is a flow diagram of a printing method.

FIG. 10 is a cut-away schematic side view of a print head.

FIG. 11 is a scanning electron microscope (SEM) view of a printed silver nanoparticle line having a line width of approximately 1 μm.

FIG. 12 is a scanning electron microscope (SEM) view of a printed silver nanoparticle line having a line width of approximately 5 μm.

FIG. 13 is a scanning electron microscope (SEM) view of a printed silver nanoparticle line having a line width of approximately 10 μm.

FIG. 14 is a scanning electron microscope (SEM) view of a printed silver nanoparticle line having a line width of approximately 15 μm.

FIG. 15 is a scanning electron microscope (SEM) view of a printed silver nanoparticle line having a line width of approximately 25 μm.

FIG. 16 is a scanning electron microscope (SEM) view of a printed silver nanoparticle line having a line width of approximately 100 μm.

FIG. 17 is an ultraviolet-visible (UV-vis) absorption spectrum of obtained silver nanoparticles after synthesis.

FIG. 18 is an ultraviolet-visible (UV-vis) absorption spectrum of obtained silver nanoparticles after purification.

FIG. 19 is transmission electron micrograph of purified silver nanoparticles, at lower magnification.

FIG. 20 is transmission electron micrograph of purified silver nanoparticles, at higher magnification.

### DETAILED DESCRIPTION OF ILLUSTRATIVE EMBODIMENTS

Applicant of the present application owns the following Poland Patent Applications, the disclosure of each of which is herein incorporated by reference in its entirety:

Poland Application No. PL429145 titled FLUID PRINTING APPARATUS, filed Mar. 5, 2019;

Poland Application No. PL429147 titled METHOD OF PRINTING FLUID, filed Mar. 5, 2019;

Poland Application No. PL428963 titled CONDUCTIVE INK COMPOSITIONS, filed Feb. 19, 2019;

Poland Application No. PL428769 titled FLUID PRINTING APPARATUS, filed Feb. 1, 2019; and

Poland Application No. PL428770 titled METHOD OF PRINTING FLUID, filed Feb. 1, 2019.

The present disclosure relates to conductive ink compositions and methods of preparing these conductive ink compositions.

In this disclosure:

The words “preferred” and “preferably” refer to embodiments of the claimed subject matter that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the claimed subject matter.

The terms “comprises” and variations thereof do not have a limiting meaning where these terms appear in the description and claims.

Unless otherwise specified, “a,” “an,” “the,” and “at least one” are used interchangeably and mean one or more than one.

The recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

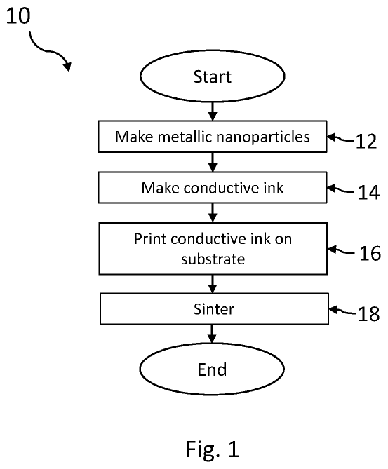

FIG. 1 is a flow diagram of a process 10 of forming a printed conductive feature on a printable surface of a substrate. In the present disclosure, metallic nanoparticles are used to form the conductive features. Among various metallic nanoparticles, silver nanoparticles (AgNPs) have become increasingly important for use in the electronics industries. Accordingly, the present disclosure is directed mainly toward the optimization of conductive ink compositions containing silver nanoparticles. At step 12, the metallic nanoparticles are made. The synthesis of silver nanoparticles is described in detail in Nanoparticle Examples 1 through 4 hereinbelow. Generally, the synthesis of silver nanoparticles in solution employs three components: (1) metal precursors (e.g., AgNO₃); (2) reducing agents (e.g., ethylene glycol); and (3) stabilizing (capping) agents (e.g., polyvinylpyrrolidone). Polyvinylpyrrolidone, abbreviated as PVP, is soluble in water and other polar solvents. When PVP is effectively used as a dispersant, stable colloidal silver nanoparticles covered (capped) with PVP polymer can be obtained in very small size (<100 nm) because the PVP reduces the aggregation of the silver nanoparticles.

The average size of the silver nanoparticles can be controlled to within a range of 35 nm to 65 nm, or within a range of 20 nm to 80 nm. The average particle size and dispersity can be controlled by controlling thermodynamic and kinetic reaction parameters. Reaction temperature, temperature ramp, and reaction time are the important thermodynamic reaction parameters. In second case, the reagents addition rate of adding reagents and molar ratio of used metal precursor to stabilizing agent (PVP) are the important kinetic reaction parameters. An appropriate combination of these parameters leads to obtaining nanoparticles that exhibit the desired properties of small particles size, low dispersity, and high dispersion stability (low occurrence of aggregation).

At step 14, a conductive ink is made from the metallic nanoparticles from step 12. The preparation of conductive ink compositions is described in detail in Ink Examples 1 through 6 and Ink Comparative Examples 1 through 8 hereinbelow. Generally, the silver nanoparticles are separated, to remove impurities and excess PVP, and dispersed in a first solvent. Optionally, a second solvent is added to the ink composition. The conductive ink composition may optionally include additives to better control its physicochemical properties. These additives include surfactants, binders, adhesion promoters, and antifoaming agents. We have found that the concentration of such additives should not exceed 1% by weight in the conductive ink composition.

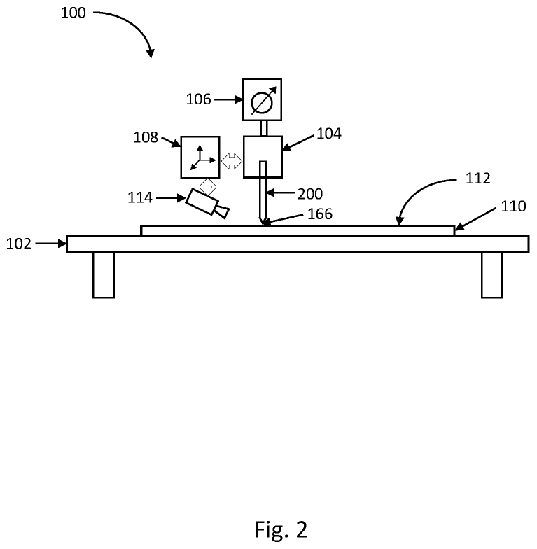

At step 16, the conductive ink composition is printed on a printable surface of a substrate using a fluid printing apparatus. Details of an illustrative fluid printing apparatus and methods of printing are described in detail with reference to FIGS. 2 through 10. Nevertheless, the conductive ink compositions described herein are not limited to being used in these illustrative fluid printing apparatuses.

At step 18, the work piece, i.e., the substrate with the conductive feature thereon, is sintered. For example, sintering can be done in a convection oven in a range of 120° C. to 200° C. for 5 minutes. In this temperature range, the sintering process is compatible with plastic substrates. Alternatively, photonic sintering, such as by using a laser or a flash lamp, can be used. The use of PVP as a capping agent reduces the aggregation of silver nanoparticles, but the capping of the nanoparticle surfaces by PVP results in lower electrical conductivity. The sintering process removes the PVP and organic remains. Silver nanoparticles exhibit poor electrical conductivity when they are sintered at less than 120° C.

TABLE 1

| | | | | | | No. of | Surface | |
|---|---|---|---|---|---|---|---|---|
| | Molecular | Density | Boiling point | Viscosity | | hydroxyl | tension | Use in Ink |
| Solvent | weight | (g/ml) | (° C.) | (cP) | | groups | (mN/m) | Composition |
| Methanol | 32.04 | 0.791 | 64.7 | 0.55 | (20° C.) | 1 | 22.1 | |
| Ethanol | 46.07 | 0.816 | 78 | 1.1 | (25° C.) | 1 | 22.0 | |
| 2-Propanol | 60.10 | 0.785 | 82.4 | 2.1 | (25° C.) | 1 | 23.3 | |
| 1-Propanol | 60.10 | 0.804 | 97 | 2.26 | (20° C.) | 1 | 20.9 | |
| Water | 18.02 | 1.000 | 100 | 1.0 | (20° C.) | 1 | 72.7 | |
| 2-Methoxyethanol | 76.09 | 0.965 | 124 | 1.72 | (20° C.) | 1 | 42.8 | |
| 2-Butoxyethanol | 118.18 | 0.900 | 171 | 2.9 | (25° C.) | 1 | 26.6 | |
| Propylene glycol | 76.09 | 1.036 | 187.4 | 48.6 | (25° C.) | 2 | 45.6 | First Solvent |
| Ethylene glycol | 62.07 | 1.113 | 197 | 16.9 | (25° C.) | 2 | 48.4 | First Solvent |
| Diethylene glycol | 106.12 | 1.118 | 245 | 35.7 | (25° C.) | 2 | 44.8 | First Solvent |
| Glycerol | 92.09 | 1.261 | 290 | 1408 (20° C.), | | 3 | 63.4 | Second |
| | | | | 610 (30° C.) | | | | Solvent |
| Tetraethylene | 194.23 | 1.124 | 329 | 58.3 | (25° C.) | 2 | 44.0 | |
| glycol | | | (decomposes) | | | | | |

Since PVP is soluble in water and other polar solvents, several polar solvents were used to make silver nanoparticle ink compositions. The 12 candidate solvents and their physicochemical properties are summarized in Table 1, ordered by boiling point. The candidate solvents are all polar solvents, with 1, 2, or 3 hydroxyl groups in the molecular structure. The boiling point ranges from 64.7° C. (methanol) to 329° C. (temperature at which tetraethylene glycol decomposes), and the viscosity ranges from 0.55 cP (methanol) to 1408 cP (glycerol).

Sixteen different silver nanoparticle ink compositions have been considered. Each ink composition is a result of nanoparticle synthesis by one of 4 Nanoparticle Examples, followed by ink preparation by one of 6 Ink Examples or 8 Ink Comparative Examples. The ink compositions are summarized in Table 2 below. The silver nanoparticles are dispersed in a first solvent only in

Ink Nos. 5, 12, 13, 14, 15, and 16, and silver nanoparticles are dispersed in first and second solvents in Ink Nos. 1, 2, 3, 4, 6, 7, 8, 9, 10, and 11.

TABLE 2

| Ink | Nanoparticle | Ink | | | Ink |
|---|---|---|---|---|---|
| No. | Example | Example | First Solvent | Second Solvent | Stability |
| 1 | 1 | Example 1 | Propylene Glycol | Glycerol | Excellent |
| 2 | 2 | Example 1 | Propylene Glycol | Glycerol | Poor |
| 3 | 3 | Example 1 | Propylene Glycol | Glycerol | Fair |
| 4 | 1 | Example 2 | Propylene Glycol | Glycerol | Fair |
| 5 | 1 | Example 3 | Propylene Glycol | None | Fair |
| 6 | 4 | Example 4 | Propylene Glycol | Glycerol | Excellent |
| 7 | 1 | Example 5 | Ethylene Glycol | Glycerol | Good |
| 8 | 1 | Example 6 | Diethylene Glycol | Glycerol | Fair |
| 9 | 1 | Comparative 1 | 2-Butoxyethanol | Glycerol | Poor |
| 10 | 1 | Comparative 2 | 2-Methoxyethanol | Glycerol | Poor |
| 11 | 1 | Comparative 3 | Propylene Glycol | Tetraethylene Glycol | Poor |
| 12 | 1 | Comparative 4 | Water | None | Poor |
| 13 | 1 | Comparative 5 | Methanol | None | Fair |
| 14 | 1 | Comparative 6 | Ethanol | None | Poor |
| 15 | 1 | Comparative 7 | 1-Propanol | None | Poor |
| 16 | 1 | Comparative 8 | 2-Propanol | None | Fair |

Ink Nos. 13, 14, and 16 contain first solvents methanol (boiling point 64.7° C.), ethanol (boiling point 78° C.), and 2-propanol (boiling point 82.4° C.), respectively. No second solvents were added in preparing these inks. Each ink was dispensed (printed) using the illustrative fluid printing apparatus and printing method. It was observed that dispensing (printing) of the ink was noticeably more difficult to control because of the rapid vaporization of the solvent, as compared to other inks described herein. The rapid vaporization of the solvent also creates more inhomogeneities in the dispensed (printed) features than with other inks. Features with greater inhomogeneities require sintering for longer periods and/or higher temperatures. Accordingly, certain lower boiling point solvents such as methanol, ethanol, and 2-propanol are not preferred for use in these conductive ink compositions.

The stability of an ink was measured by placing a sample of the ink in a cuvette and measuring the ultraviolet-visible (UV-vis) absorption spectra as a function of time. In Table 2, Ink Stability is defined as the time period over which most of the silver nanoparticles remain in suspension in the cuvette ink sample, as determined by the UV-vis absorption spectra. Ink Stability is described as one of the following: (1) Poor—stable for 1 week or less; (2) Fair—stable for 2 weeks or less, but better than Poor; (3) Good—stable for 1 month or less, but better than Fair; and (4) Excellent—better stability than Good. It has been found that inks with better stability tend to exhibit less nanoparticle agglomeration in the micro-structural fluid ejector of the print head.

Ink Nos. 12, 13, 14, 15, and 16 contain solvents with boiling points of 100° C. or lower, namely water, methanol, ethanol, 1-propanol, and 2-propanol, respectively. These inks exhibit fair or poor stability. Even though the inks that contain methanol (Ink No. 13) and 2-propanol (Ink. No. 16) exhibit fair stability (instead of poor stability), the solvents methanol and 2-propanol are not preferred for use in the conductive ink compositions because of the difficulties of controlling ink dispensing and the inhomogeneities in the dispensed features, as described above.

Ink No. 1 is an ink composition that contains a first solvent of propylene glycol (boiling point 187.4° C., viscosity 48.6 cP, 2 hydroxyl groups) and a second solvent of glycerol (boiling point 290° C., viscosity ^{˜}10³ cP, 3 hydroxyl groups), in which a concentration of glycerol in the conductive ink composition is about 17.8% by volume. The concentration of silver nanoparticle in the ink is about 21.4 wt %. Ink No. 1 was measured to have excellent stability. It is thought that the two solvents of relatively high boiling points and relatively large viscosities contributed to the ink stability. The extremely large viscosity of glycerol is attributable to the presence of three hydroxyl groups; therefore, glycerol is hygroscopic. However, no water was intentionally added to the ink composition. Since water, methanol, ethanol, 1-propanol, and 2-propanol tend to degrade the performance of the ink containing them, it is preferable to limit the use of water, methanol, ethanol, 1-propanol, and 2-propanol in the conductive ink composition. It is preferable to limit the concentration of water, methanol, ethanol, 1-propanol, and 2-propanol, in aggregate, to 10.0% or less of the conductive ink composition by volume. As described in detail below, Ink No. 1 was used to print conductive features on a glass substrate. For example, a mesh printed using Ink No. 1 was measured to have a sheet resistance of 5 Ω/sq or less.

Ink No. 1 used silver nanoparticles made according to Nanoparticle Example 1, in which the capping agent was PVP of viscosity grade K-30. Ink No. 2 used silver nanoparticles made according to Nanoparticle Example 2, in which the capping agent was PVP of viscosity grade K-15. The molecular weight of the PVP used in Ink No. 2 was lower. Ink No. 2 was prepared according to Ink Example 1. Ink No. 2 was observed to have poor stability. Hence, it is possible that the PVP used in Nanoparticle Example 2 was not sufficiently effective as a dispersant and capping agent of the silver nanoparticles.

Ink No. 3 used silver nanoparticles made according to Nanoparticle Example 3, in which the temperature of hot injection was lowered, compared to Nanoparticle Example 1. The PVP solution, into which the metal precursor solution was poured, was at 100° C. (instead of 120° C., as in Nanoparticle Example 1). Ink No. 3 was prepared according to Ink Example 1. Ink No. 3 was observed to have fair stability.

Ink No. 4 used silver nanoparticles made according to Nanoparticle Example 1. Ink No. 4 was prepared according to Ink Example 2, in which a concentration of glycerol in the conductive ink composition is about 10.4% by volume (instead of 17.8% by volume as in Ink Example 1). In other words, the concentration of glycerol is reduced. Ink No. 4 was observed to have fair stability.

Ink No. 5 used silver nanoparticles made according to Nanoparticle Example 1. Ink No. 5 was prepared according to Ink Example 3, in which glycerol was not added, so the sole solvent was the first solvent propylene glycol. Ink No. 5 was observed to have fair stability. Upon comparing Ink Nos. 1, 4, and 5, one can deduce that adding glycerol as a second solvent to propylene glycol, with a concentration of glycerol in the conductive ink composition is 11.0% by volume or greater, provides conductive ink compositions with improved stability.

Ink No. 6 used silver nanoparticles made according to Nanoparticle Example 4. Compared to Nanoparticle Example 1, the hot injection temperature was increased from 120° C. to 140° C. This is based on the finding from Ink No. 3 which exhibited fair stability. Ink No. 3 used silver nanoparticles made according to Nanoparticle Example 3 in which the hot injection temperature was 100° C. Ink No. 6 was prepared according to Ink Example 4, whose important differences from Ink Example 1 are: (1) nanoparticle concentration of 34.8 wt % instead of 21.4 wt %; and (2) filtration step omitted after re-dispersion in ethanol. Ink No. 6 was observed to have excellent stability. We have demonstrated conductive ink compositions containing metallic nanoparticles at concentrations as high as 65 wt % and 75 wt %.

Ink No. 7 used silver nanoparticles made according to Nanoparticle Example 1. Ink No. 7 was prepared according to Ink Example 5, in which ethylene glycol was used instead of propylene glycol as the first solvent (Ink Example 1), and glycerol was used as the second solvent. Ethylene glycol has a boiling point of 197° C., a viscosity of 16.9 cP, and 2 hydroxyl groups. Ink No. 7 was observed to have good stability.

Ink No. 8 used silver nanoparticles made according to Nanoparticle Example 1. Ink No. 8 was prepared according to Ink Example 6, in which diethylene glycol was used instead of propylene glycol as the first solvent (Ink Example 1), and glycerol was used as the second solvent. Diethylene glycol has a boiling point of 245° C., a viscosity of 35.7 cP, and 2 hydroxyl groups. Ink No. 8 was observed to have fair stability.

Ink No. 9 used silver nanoparticles made according to Nanoparticle Example 1. Ink No. 9 was prepared according to Ink Comparative Example 1, in which 2-butoxyethanol was used instead of propylene glycol as the first solvent (Ink Example 1), and glycerol was used as the second solvent. 2-Butoxyethanol has a boiling point of 171° C., a viscosity of 2.9 cP, and 1 hydroxyl group. Ink No. 9 was observed to have poor stability.

Ink No. 10 used silver nanoparticles made according to Nanoparticle Example 1. Ink No. 10 was prepared according to Ink Comparative Example 1, in which 2-methoxyethanol was used instead of propylene glycol as the first solvent (Ink Example 1), and glycerol was used as the second solvent. 2-Methoxyethanol has a boiling point of 124° C., a viscosity of 1.72 cP, and 1 hydroxyl group. Ink No. 10 was observed to have poor stability. Upon comparing Ink Nos. 1, 7, 8, 9, and 10, one can deduce that 2-butoxyethanol and 2-methoxyethanol are not preferred choices as a first solvent and that propylene glycol, ethylene glycol, and diethylene glycol are preferred choices as a first solvent. All of the candidate solvents 2-methoxyethanol, 2-butoxyethanol, propylene glycol, ethylene glycol, and diethylene glycol have boiling points of at least 110° C. The preferred solvents propylene glycol, ethylene glycol, and diethylene glycol have viscosities of at least 10 cP at 25° C., and the non-preferred solvents 2-methoxyethanol and 2-butoxyethanol have viscosities less than 10 cP at 25° C. The preferred solvents propylene glycol, ethylene glycol, and diethylene glycol each has 2 hydroxyl groups, and the non-preferred solvents 2-methoxyethanol and 2-butoxyethanol each has 1 hydroxyl group.

Ink No. 11 used silver nanoparticles made according to Nanoparticle Example 1. Ink No. 11 was prepared according to Ink Comparative Example 3, in which propylene glycol was used as the first solvent, and tetraethylene glycol was used instead of glycerol as the second solvent (Ink Example 1). Tetraethylene glycol decomposes at 329° C., has a viscosity of 58.3 cP, and has 2 hydroxyl groups. Ink No. 11 was observed to have poor stability. Upon comparing Ink Nos. 1 and 11, one can deduce that tetraethylene glycol is not a preferred choice as a second solvent and that glycerol is a preferred choice as a second solvent. Both of the candidate solvents tetraethylene glycol and glycerol have boiling points of at least 200° C. The preferred solvent glycerol has a viscosity of at least 100 cP at 25° C., and the non-preferred solvents tetraethylene glycol has a viscosity less than 100 cP at 25° C. The preferred solvent glycerol has 3 hydroxyl groups, and the non-preferred solvents tetraethylene glycol has 2 hydroxyl groups.

Ink Nos. 12, 13, 14, 15, and 16 used silver nanoparticles made according to Nanoparticle Example 1. Ink No. 12 was prepared according to Ink Comparative Example 4, in which water was used as the sole solvent. Ink No. 13 was prepared according to Ink Comparative Example 5, in which methanol was used as the sole solvent. Ink No. 14 was prepared according to Ink Comparative Example 6, in which ethanol was used as the sole solvent. Ink No. 15 was prepared according to Ink Comparative Example 7, in which 1-propanol was used as the sole solvent. Ink No. 16 was prepared according to Ink Comparative Example 8, in which 2-propanol was used as the sole solvent. Stability results for these inks have been described above.

The conductive ink compositions of the present disclosure are suitable for use in fluid printing apparatuses. Illustrative fluid printing apparatuses and methods of printing are described with reference to FIGS. 2 through 10.

An illustrative fluid printing apparatus is explained with reference to FIG. 2. FIG. 2 is a block diagram view of an illustrative fluid printing apparatus. The fluid printing apparatus 100 includes a substrate stage 102, a print head 104, a pneumatic system 106, and a print head positioning system 108. A substrate 110 is fixed in position on the substrate stage 102 during the printing and has a printable surface 112, which is facing upward and facing towards the print head 104. The print head 104 is positioned above the substrate 110.

The substrate 110 can be of any suitable material, such as glass, plastic, metal, or silicon. A flexible substrate can also be used. Furthermore, the substrate can have existing metal lines, circuitry, or other deposited materials thereon. For example, the present disclosure relates to an open defect repair apparatus, which can print lines in an area where there is an open defect in the existing circuit. In such case, the substrate can be a thin-film transistor array substrate for a liquid crystal display (LCD).

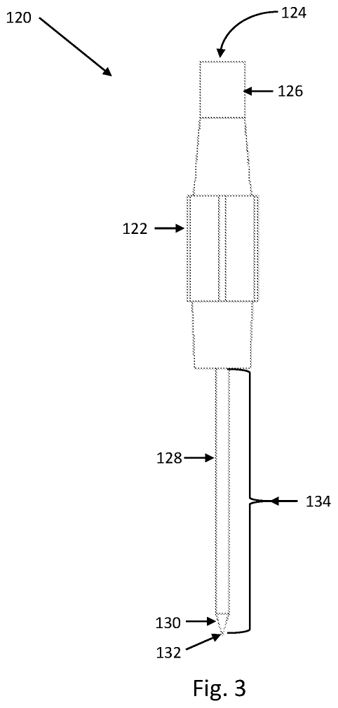

The print head includes a micro-structural fluid ejector. Commercially available capillary glass tubes can be modified to be used as the micro-structural fluid ejector. For example, capillary glass tubes called Eppendorf™ Femtotips™ Microinjection Capillary Tips, with an inner diameter at the tip of 0.5 μm, are available from Fisher Scientific. A commercially available capillary glass tube 120 is shown schematically in FIG. 3. A plastic handle 122 is attached to the capillary glass tube 120 around its circumference. The plastic handle 122 includes an input end 124 and a threaded portion 126 near the input end 124 which enables a threaded connection to an external body or external conduit (not shown in FIG. 3). The input end 124 has an inner diameter of 1.2 mm.

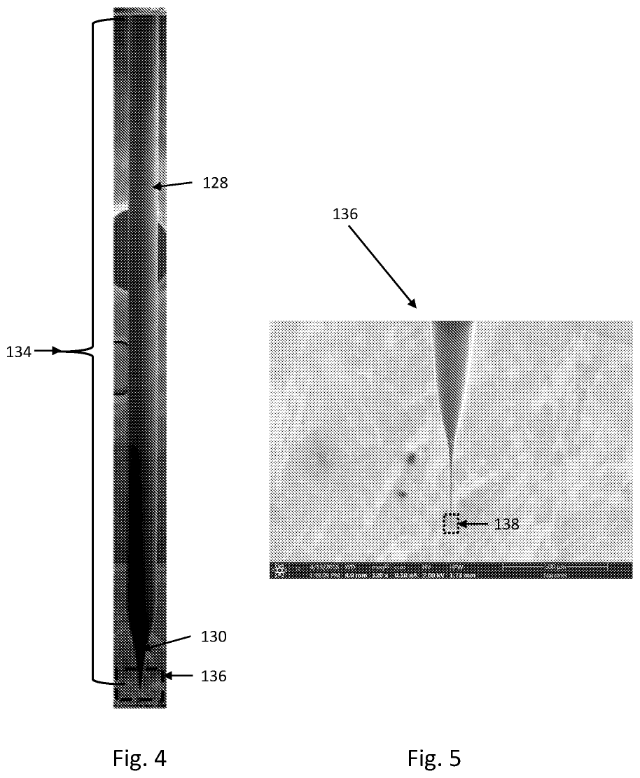

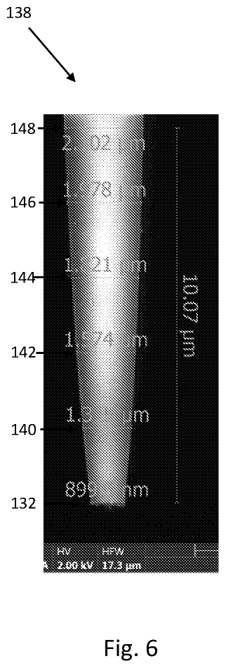

The capillary glass tube includes an elongate input portion 128 and a tapering portion 130. There is an externally visible portion 134 of the capillary glass tube 120. Some of the elongate input portion 128 may be obscured by the surrounding plastic handle 122. The tapering portion 130 tapers to an output end 132 with a nominal inner diameter of 0.5 μm. The reduction of diameter along the tapering portion 130 from the elongate input portion 128 to the output end 132 is more clearly illustrated in FIGS. 4 through 6. FIG. 4 is a scanning electron micrograph view (formed from stitching together multiple SEM images) of the entire externally visible portion 134 of the capillary glass tube 120. A first magnification region 136 of the tapering portion 130 including the output end 132, observed under low magnification in a scanning electron microscope (SEM), is shown in FIG. 5. Furthermore, a second magnification region 138 located within the first magnification region 136, observed under high magnification in a scanning electron microscope (SEM), is shown in FIG. 6. The outer diameter measured at the output end 132 and at different longitudinal locations along the tapering portion (140, 142, 144, 146, and 148) are shown in FIG. 6 and in Table 3. The outer diameter is smallest at the output end 132 and increases with increasing longitudinal distance from the output end 132. A longitudinal distance 90 between output end 136 and longitudinal location 148 is measured to be approximately 10.07 μm.

TABLE 3

| Longitudinal Location | Outer diameter (μm) |
|---|---|
| 148 | 2.102 |
| 146 | 1.978 |
| 144 | 1.821 |
| 142 | 1.574 |
| 140 | 1.315 |
| 132 | 0.8993 |

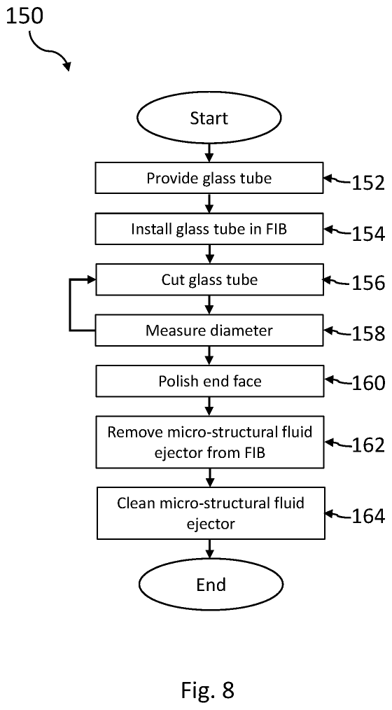

In a case where the output inner diameter (nominally 0.5 μm in this example) is too small, it is possible to increase the output inner diameter by cutting the capillary glass tube 120 at a suitable longitudinal location along the tapering portion 130, for example longitudinal location 140, 142, 144, 146, or 148. A method 150 of treating the capillary glass tube 120 to obtain a micro-structural fluid ejector 200 is shown in FIG. 8. At step 152, a capillary glass tube 120, such as shown in FIG. 3 is provided. At step 154, the capillary glass tube is installed in a focused-ion beam (FIB) apparatus. For example, a plasma-source Xe⁺ FIB (also called PFIB) is used. At step 156, a longitudinal location along the tapering portion 130 is selected, and the focused ion beam is directed to it, with sufficient energy density for cutting the glass tube. At step 156, a cut is made using the focused-ion beam across the tapering portion at the selected longitudinal location. After the previous step 156 is completed, a scanning electron microscope (in the FIB apparatus) is used to measure the inner diameter at the output end (step 158). If the measured inner diameter is too small, step 156 is carried out at another longitudinal location along the tapering portion, and step 158 is carried out. Steps 156 and 158 are repeated until the desired inner diameter is obtained.

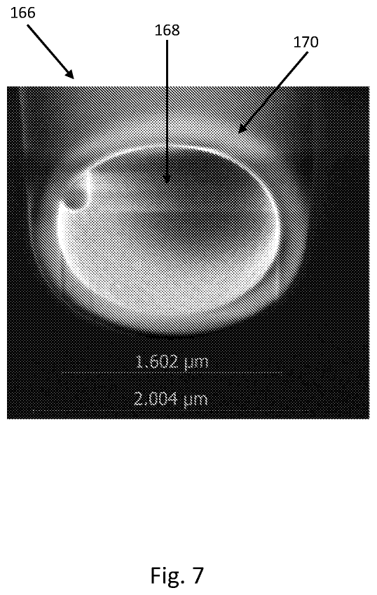

As shown in FIG. 7, the final cutting (step 156) defines an output portion 166 including the exit orifice 168 and the end face 170. In many cases, the exit orifice 168 has an output inner diameter ranging between 0.1 μm and 5 μm. However, the output inner diameter can be chosen to be greater than 5 μm. In the example shown in FIG. 7, the output inner diameter is measured to be 1.602 μm and the output outer diameter is measured to be 2.004 μm. Then, at step 160, the energy of the focused ion beam is reduced, and the focused ion beam is directed to the end face 170. The end face 170 is polished using the focused ion beam, to obtain an end face with a surface roughness of less than 0.1 μm, and preferably ranging between 1 nm and 20 nm. In the end face example shown in FIG. 7, it can be deduced from the outer and inner diameter dimensions that the end face has a surface roughness of less than 0.1 μm. When the polishing capability of the FIB apparatus is taken into account, it is considered likely that the surface roughness of the end face ranges between 1 nm and 20 nm. Upon the conclusion of step 160, a micro-structural fluid ejector 200 is obtained. Then, at step 162, the micro-structural fluid ejector 200 is removed from the FIB apparatus. Additionally, it is preferable to clean the micro-structural fluid ejector, particularly the output portion, by immersion in a solvent while applying pressure in the range of 10,000 Pa to 1,000,000 Pa (step 164). We have found it effective to use a solvent that is identical to a solvent used in the fluid. For example, if the fluid contains propylene glycol, it is found effective to use propylene glycol as a solvent for cleaning in this step 164. The foregoing is a description of an example of a micro-structural fluid ejector obtained by modification of a capillary glass tube. More generally, it is contemplated that micro-structural fluid ejector can be obtained from other materials, such as plastics, metals, and silicon, or from a combination of materials.

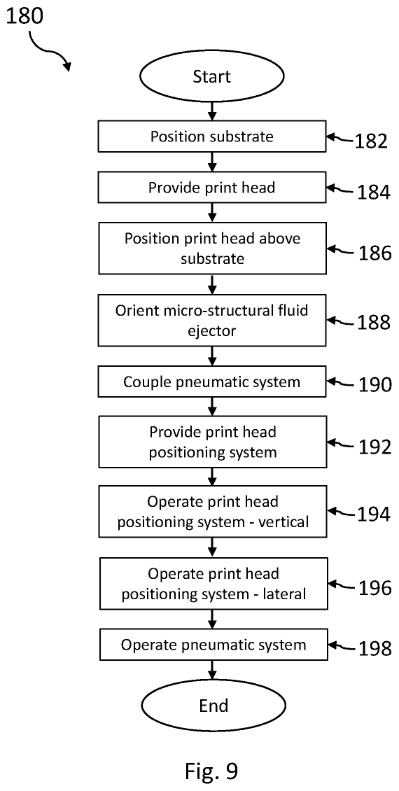

Upon completion of step 162 and/or step 164, the micro-structural fluid ejector 200 is ready to install in the print head. FIG. 9 is a flow diagram of a printing method 180, in which a fluid printing apparatus is operated (FIG. 2). At step 182, a substrate 110 is positioned at a fixed position on a substrate stage 102. At step 184, a print head 104 is provided. This step includes preparing the micro-structural fluid ejector, as described in FIG. 8, and installing it in a print head 104. At step 186, the print head 104 is positioned above the substrate 110 (FIG. 2). At step 188, the micro-structural fluid ejector 200 is oriented with the exit orifice 168 pointing downward and the end face 170 facing toward the printable surface 112 of the substrate 110. At step 190, a pneumatic system 106 is coupled to the print head 104. For example, the pneumatic system includes a pump and a pressure regulator.

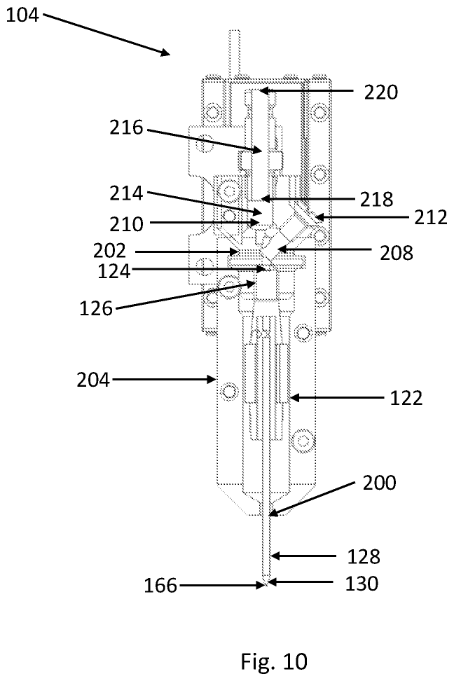

An example of a print head 104 is shown in FIG. 10. The print head 104 includes a micro-structural fluid ejector 200. A portion of the micro-structural fluid ejector 200, and its plastic handle 122, are encased in the external housing 204. The elongate input portion 128 extends downward from the external housing 204. An output portion 166, including the exit orifice 168 and end face 170 (FIG. 7), are located downward from the elongate input portion 128. The tapering portion 130 is located between the output portion 166 and the elongate input portion 128. The external housing 204 encases a main body 202, which includes a pneumatic conduit 210 and a fluid conduit 208. Both the pneumatic conduit 210 and the fluid conduit 208 are connected to the input end 124 of the plastic handle 122. The plastic handle 122 is attached to the main body 202 by the threaded portion 126 of the plastic handle 122. The pneumatic conduit 210 has a threaded portion 214 on its input end which is used to attach the output end 218 of a pneumatic connector 216 thereto. The pneumatic connector 216 has an input end 220 to which the pneumatic system 106 is connected (not shown in FIG. 10). Fluid (for example, ink) is supplied to the micro-structural fluid ejector 200 via the fluid conduit 208. As shown in FIG. 10, fluid conduit 208 is plugged with a fluid inlet plug 212, after fluid has been supplied to the micro-structural fluid ejector 200. The ink can be stored in the micro-structural fluid ejector 200 in the print head 104, or the ink can be stored in a fluid reservoir that supplies ink to the print head 104 via the fluid conduit 208.

The printing method 180 is explained with continuing reference to FIG. 9. At step 192, a print head positioning system 108 is provided. The print head positioning system 108 controls the vertical displacement of the print head 104 and the lateral displacement of the print head 104. At step 194, the print head positioning system 108 is operated to control a vertical distance between the end face 170 and the printable surface 112 to within a range of 0 μm to 5 μm during the printing. At step 196, the print head positioning system 108 is operated to laterally displace the print head during the printing. At step 198, the pneumatic system 106 is operated, to apply pressure to the fluid in the micro-structural fluid ejector 200 via the elongate input portion 128. During the printing, the pressure is regulated to within a range of −50,000 Pa to 1,000,000 Pa.

The print head positioning system 108 controls the vertical distance between the end face 170 and the printable surface 112 to within 0 μm and 5 μm during the printing. In the fluid printing apparatus 100, the print head can 104 can eject a continuous stream of fluid through the exit orifice. Since the stream of fluid is continuous, a line of fluid can be formed on the printable surface 112. The line of fluid can be dried and/or sintered thereafter. It has been found that the print head positioning system 108 can laterally displace the print head at speeds within a range of 0.01 mm/sec to 1000 mm/sec during the printing. The line width of the line formed on the printable surface 112 depends in part on the size of the exit orifice 168, namely the output inner diameter. It has been found that when the print head positioning system 108 laterally displaces the print head at speeds within a range of 0.01 mm/sec to 1000 mm/sec during, the line width is greater than the output inner diameter by a factor ranging between 1.0 and 20.0.

During the printing, the pressure is regulated to within a range of −50,000 Pa to 1,000,000 Pa and the vertical distance between the end face 170 and the printable surface 112 is maintained within a range of 0 μm to 5 μm. The appropriate pressure range depends in part on the viscosity of the fluid. It is possible to print fluids in the range of 1 to 2000 centipoise. For lower viscosity fluids, in a range of 1 to 10 centipoise, the pressure is regulated to within a range of −50,000 Pa to 0 Pa during the printing. For these lower viscosity fluids, a negative pressure is needed to prevent excessive fluid flow out of the exit orifice 168. For fluids having a viscosity within a range of 100 to 200 centipoise, the pressure is regulated to within a range of 20,000 Pa to 80,000 Pa during the printing. It is hypothesized that a meniscus protrudes from the exit orifice 168 and contacts the printable surface 112, and there is wetting tension by virtue of contact between the fluid and the printable surface 112. In order to stop the flow of fluid onto the printable surface 112, the print head positioning system 108 increases the vertical distance between the end face 170 and the printable surface 112 to 10 μm or more. It has been found that reduction of the pressure at the end of printing on the printable surface can lead to clogging of the fluid in the micro-structural fluid ejector. Therefore, by increasing the vertical distance to 10 μm or more, the fluid continues to be ejected through the exit orifice 168 and accumulates on the outer wall of the micro-structural fluid ejector, instead of being printed on the printable surface 112. Fluids that can be printed include nanoparticle inks, such as inks containing titanium dioxide nanoparticles and silver nanoparticles. Other metallic nanoparticles including gold nanoparticles and copper nanoparticles are possible. The nanoparticles can be quantum dot nanoparticles, such as CdSe, CdTe, and ZnO. Inks containing carbon black can also be printed.

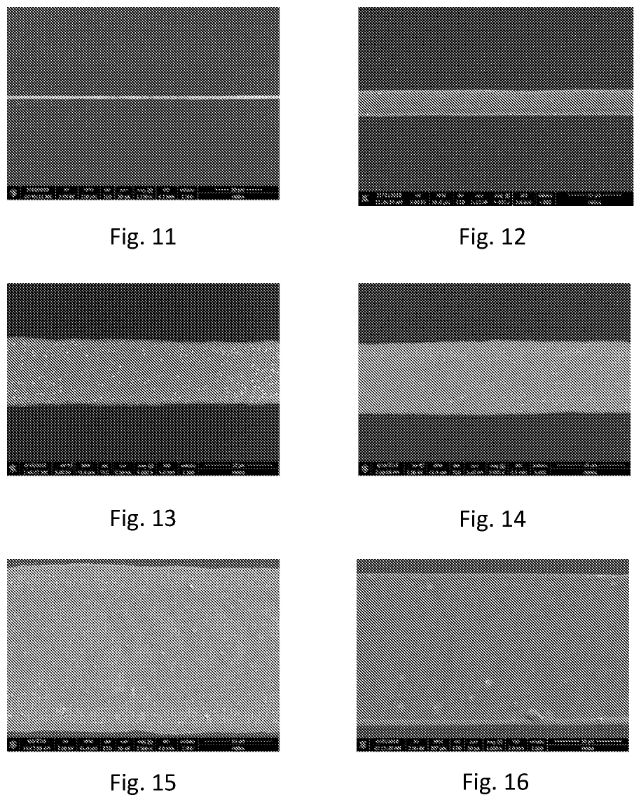

Ink No. 1 (Silver nanoparticle ink in a first solvent of propylene glycol and a second solvent of glycerol) was installed in the fluid printing apparatus. Conductive lines of varying linewidths were printed on a printable surface of a substrate. Examples of printed conductive lines are shown in FIGS. 11 (linewidth 1 μm), 12 (linewidth 5 μm), 13 (linewidth 10 μm), 14 (linewidth 15 μm), 15 (linewidth 25 μm), and 16 (linewidth 100 μm). The linewidths were adjusted by preparing micro-structural fluid ejectors of varying output inner diameters, and by optimizing the pressure and speed of printing (lateral displacement). The physicochemical properties of the ink also significantly affect the quality of printing and the linewidth. The output inner diameter of the exit orifice 168 was varied as shown in Table 4. FIGS. 11, 12, 13, 14, 15, and 16 show specific examples of conductive lines. Other conductive features, in the form of a dot, a curve, a broken line, and other geometrical patterns are possible by dispensing the present conductive ink compositions. The sheet resistance of a mesh printed on a glass substrate using Ink No. 1 is measured to be 5 Ω/sq or less.

TABLE 4

| Linewidth (μm) | Output inner diameter (μm) |
|---|---|
| 1 | 0.7 |
| 5 | 2.5 |
| 10 | 5 |
| 15 | 5 |
| 25 | 15 |
| 100 | 60 |

### EXAMPLES

### Nanoparticle Example 1

Stage A. Reagents Preparation

Synthesis of PVP-capped silver nanoparticles (AgNP's) with average diameter of 50 nm was performed by using the polyol, precursor hot injection method.

50.1 g of polyvinylpyrrolidone (PVP) powder (viscosity grade K-30) was transferred into 250 ml three-neck reaction flask with magnetic stirring bar, and then 125 ml of ethylene glycol was added. Reaction flask was placed in heating mantle and heated to 100° C. under vigorous stirring with glass rod to initially dissolve PVP powder. At 100° C. reflux condenser was set, and solution was heated to 120° C., and kept in this temperature under magnetic stirring at 400 RPM (revolutions per minute). Orange color of solution was observed.

Concurrently, 6.25 g of AgNO₃ was placed into 50 ml beaker with 25.0 ml of ethylene glycol and covered with tinfoil. Solution was magnetically stirred at 600 RPM to complete dissolution of silver salt for about 20 min (metal precursor solution).

Stage B. Synthesis

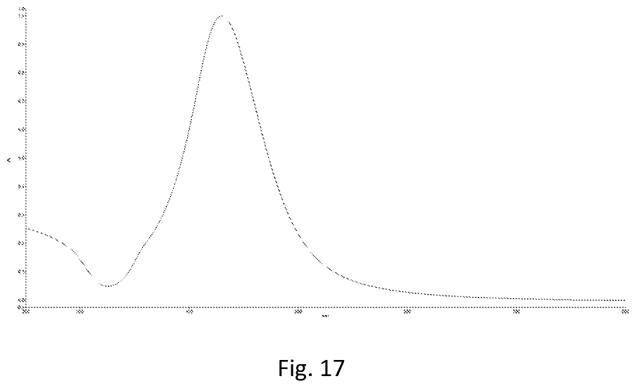

Metal precursor solution (at room temperature) in ethylene glycol was rapidly poured (below 5 sec) into reaction flask with hot PVP solution at 120° C. under stirring. Reaction mixture was heated for 60 min and cooled to room temperature (RT) in cool water bath. After addition of AgNO₃ solution, color change was observed from orange to dark red and then to dark green at final stage. After cooling, obtained dispersion was kept stirred. Small sample was collected for UV-VIS absorption spectra measurement. The UV-visible absorption spectrum of the nanoparticles after synthesis is shown in FIG. 17.

### Nanoparticle Example 2

Nanoparticle Example 2 is identical to Nanoparticle Example 1, except that in stage A, PVP of viscosity grade K-15 was used instead of PVP of viscosity grade K-30 as the nanoparticle stabilization agent.

### Nanoparticle Example 3

Nanoparticle Example 3 is identical to Nanoparticle Example 1, except: in stage A, the PVP solution was heated to 100° C. (instead of 120° C.), and in stage B, metal precursor solution (at room temperature) in ethylene glycol was rapidly poured (below 5 sec) into reaction flask with hot PVP solution at 100° C. under stirring.

### Nanoparticle Example 4

Stage A. Reagents Preparation

Synthesis of PVP-capped silver nanoparticles (AgNP's) with average diameter of 50 nm was performed by using the polyol, precursor hot injection method.

Two batches of nanoparticles dispersion were synthesized concurrently according to the same procedure as follows.

For each batch: 50.1 g of polyvinylpyrrolidone (PVP) powder (viscosity grade K-30) was transferred into 250 ml three-neck reaction flask with magnetic stirring bar, and then 125 ml of ethylene glycol was added. Reaction flask was placed in heating mantle and heated to 100° C. under vigorous stirring with glass rod to initially dissolve PVP powder. At 100° C. reflux condenser was set, and solution was heated to 140° C., and kept in this temperature under magnetic stirring at 400 RPM. Orange color of solution was observed.

Concurrently 6.25 g of AgNO₃ was placed into 50 ml beaker with 25.0 ml of ethylene glycol and covered with tinfoil. Solution was magnetically stirred at 600 RPM to complete dissolution of silver salt for about 20 min (metal precursor solution).

Stage B. Synthesis

Metal precursor solution (at room temperature) in ethylene glycol was rapidly poured (below 5 sec) into reaction flask with hot PVP solution @ 140° C. under stirring. Reaction mixture was heated for 60 min and cooled to RT in cool water bath. After addition of AgNO₃ solution, color change was observed from orange to dark red and then to dark green at final stage. After cooling, obtained dispersion was kept stirred.

### Ink Example 1

Stage C. Separation and Purification of Silver Nanoparticles

The resulting dispersion was equally divided into four 500 ml Nalgene PPCO centrifuge bottles. The procedure of washing the residuals from the reaction flask was then carried out. To the reaction flask from which the liquid was poured out, 50 ml of ethylene glycol was added and shaken. Subsequently, this liquid was poured equally into the same four Nalgene PPCO centrifuge bottles, in which there was a dispersion of nanoparticles.

Then, mixture containing 175 ml of acetone and 80 ml of ethylene glycol was added to each bottle and shaken up well to form rusty-brown precipitate suspensions. If precipitation did not proceed well, color of solution was still dark green. In that case, small volumes (single milliliters) of acetone were added drop by drop to obtain proper precipitate color. Suspensions were centrifuged at 2000×g (RCF) for 15 min. The shiny, reflective silver cakes at bottom of the bottles were obtained. The clear, orange supernatants were discarded. In next step, 30 ml of ethanol was added to each bottle in order to remove an excess of PVP and impurities after reaction. Silver nanoparticles were stirred and re-dispersed in ultrasonic bath for 10 min, at 35° C. Suspensions from all bottles were mixed and filtered through 1.0 μm Whatman nylon syringe filter. Silver nanoparticles were then centrifuged at 10,000×g for 35 minutes. Resultant, orange clear supernatant was discarded, and silver cake was re-dispersed in 30 ml of ethanol in ultrasonic bath for 10 minutes at 35° C.

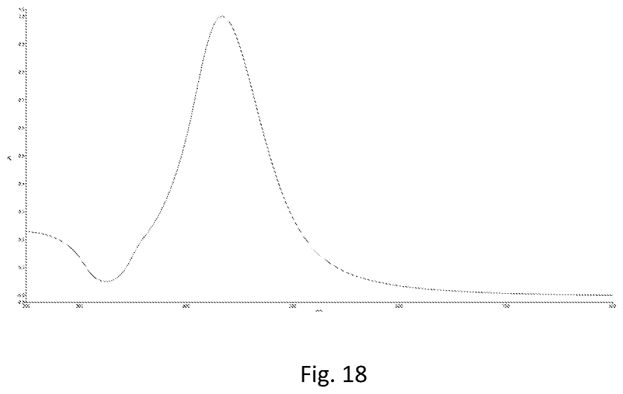

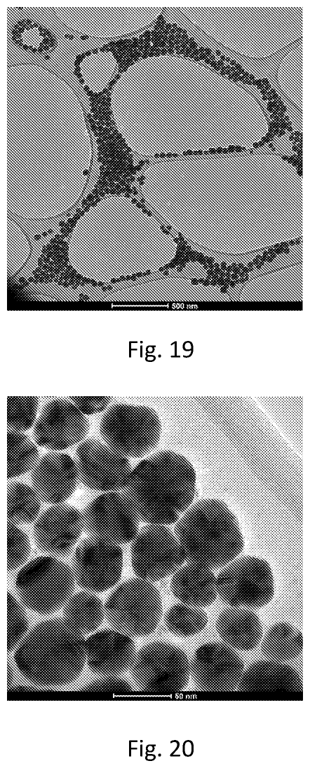

Nanoparticles dispersion was transferred to 100 ml round-bottom flask containing 6.0 ml of propylene glycol (first solvent), and gently shaken. Suspension was placed in rotary evaporator (120 RPM), at water bath temperature of 43° C., and lowered pressure of 40 mbar (4000 Pa) for 30 minutes. The resultant highly concentrated silver nanoparticles dispersion in propylene glycol (first solvent) was placed in ultrasonic bath for 5 minutes and filtered through 1.0 μm nylon syringe filter to a clean PP container (Nalgene). Suspension was stored in refrigerator at 4° C. Small volume (0.110 ml) was collected for silver mass concentration, TEM, and UV-VIS absorption spectra measurements. The UV-visible absorption spectrum of the nanoparticles after purification is shown in FIG. 18. Transmission electron micrograph images of the purified silver nanoparticles are shown in FIG. 19 (lower magnification) and in FIG. 20 (higher magnification). The average silver nanoparticles mass concentration in the concentrate samples was equal to about 26 wt %, defined as [weight of silver nanoparticles]/[volume of concentrate].

Stage D. Addition of Second Solvent

Highly concentrated silver nanoparticles dispersion (26 wt %) in propylene glycol was mixed with anhydrous glycerol (second solvent) by volume ratio 3.7:0.8 (for example 7.4 ml of AgNP's concentrate and 1.6 ml of glycerol), shaken well, and placed in ultrasonic bath for 5 minutes. The concentration of glycerol in the ink composition is about 17.8% by volume. Silver nanoparticles conductive ink was filtered through 1.0 μm nylon syringe filter and stored in PP container at 4° C. Concentration of AgNP's in obtained ink is about 21.4 wt %. Directly before using, the ink was placed in ultrasonic bath for 2 minutes. Optionally, it can be filtered by using 1.0 μm PA nylon syringe filter.

### Ink Example 2

Ink Example 2 differs from Ink Example 1, in that at stage D, highly concentrated silver nanoparticles dispersion (26 wt %) in propylene glycol was mixed with anhydrous glycerol (second solvent) by volume ratio 6:0.7 (for example 12.0 ml of AgNP's concentrate and 1.4 ml of glycerol).

### Ink Example 3

Ink Example 3 is identical to Ink Example 1, except that stage D was not carried out. No second solvent was added to the conductive ink composition.

### Ink Example 4

Stage C. Separation and Purification of Silver Nanoparticles

The resulting dispersion was equally divided into four 500 ml Nalgene PPCO centrifuge bottles. The procedure of washing the residuals from the reaction flask was then carried out. To the reaction flask from which the liquid was poured out, 50 ml of ethylene glycol was added and shaken. Subsequently, this liquid was poured equally into the same four Nalgene PPCO centrifuge bottles, in which there was a dispersion of nanoparticles.

Then, mixture containing 180 ml of acetone and 20 ml of ethylene glycol was added to each bottle and shaken up well to form rusty-brown precipitate suspensions. If precipitation did not proceed well, color of solution was still dark green. In that case, small volumes (single milliliters) of acetone were added drop by drop to obtain proper precipitate color. Suspensions were centrifuged at 2000×g (RCF) for 15 min. The shiny, reflective silver cakes at bottom of the bottles were obtained. The clear, orange supernatants were discarded. In next step, 30 ml of ethanol was added to each bottle in order to remove an excess of PVP and impurities after reaction. Silver nanoparticles were stirred and re-dispersed in ultrasonic bath for 10 min, at 35° C. Silver nanoparticles were then centrifuged at 10,000×g for 35 minutes. Resultant, orange clear supernatant was discarded, and silver cake was re-dispersed in 30 ml of ethanol in ultrasonic bath for 10 minutes at 35° C.

Two batches of nanoparticles dispersions were mixed together and transferred to 100 ml round-bottom flask containing 6.0 ml of propylene glycol, and gently shaken. Suspension was placed in rotary evaporator (120 RPM), at water bath temperature of 43° C., and lowered pressure of 40 mbar (4000 Pa) for 35 minutes. The resultant highly concentrated silver nanoparticles dispersion in propylene glycol was placed in ultrasonic bath for 5 minutes and filtered through 1.0 μm nylon syringe filter to a clean PP container (Nalgene). Suspension was stored in refrigerator at 4° C. Small volume (0.110 ml) was collected for silver mass concentration measurements. The average silver nanoparticles mass concentration in the concentrate samples was equal to about 42.3 wt %.

Stage D. Addition of Second Solvent

Highly concentrated silver nanoparticles dispersion of about 42.3 wt % in propylene glycol was mixed with anhydrous glycerol by volume ratio 3.7:0.8, shaken well, and placed in ultrasonic bath for 5 minutes. Silver nanoparticles conductive ink was filtered through 1.0 μm nylon syringe filter and stored in PP container at 4° C. Concentration of AgNP's in obtained ink is about 34.8 wt %. Directly before using, the ink was placed in ultrasonic bath for 2 minutes. Optionally, it can be filtered by using 1.0 μm PA nylon syringe filter.

### Ink Example 5

Ink Example 5 differs from Ink Example 1, in that ethylene glycol is used as first solvent instead of propylene glycol at stage C.

### Ink Example 6

Ink Example 6 differs from Ink Example 1, in that diethylene glycol is used as first solvent instead of propylene glycol at stage C.

### Ink Comparative Example 1

Ink Comparative Example 1 differs from Ink Example 1, in that 2-butoxyethanol is used as first solvent instead of propylene glycol at stage C.

### Ink Comparative Example 2

Ink Comparative Example 2 differs from Ink Example 1, in that 2-methoxyethanol is used as first solvent instead of propylene glycol at stage C.

### Ink Comparative Example 3

Ink Comparative Example 3 differs from Ink Example 1, in that tetraethylene glycol is used as second solvent instead of glycerol at stage D.

### Ink Comparative Example 4

Stage C. Separation and Purification of Silver Nanoparticles

The resulting dispersion was equally divided into four 500 ml Nalgene PPCO centrifuge bottles. The procedure of washing the residuals from the reaction flask was then carried out. To the reaction flask from which the liquid was poured out, 50 ml of ethylene glycol was added and shaken. Subsequently, this liquid was poured equally into the same four Nalgene PPCO centrifuge bottles, in which there was a dispersion of nanoparticles.

Then, mixture containing 175 ml of acetone and 80 ml of ethylene glycol was added to each bottle and shaken up well to form rusty-brown precipitate suspensions. If precipitation did not proceed well, color of solution was still dark green. In that case, small volumes (single milliliters) of acetone were added drop by drop to obtain proper precipitate color. Suspensions were centrifuged at 2000×g (RCF) for 15 min. The shiny, reflective silver cakes at bottom of the bottles were obtained. The clear, orange supernatants were discarded. In next step, 30 ml of ethanol was added to each bottle in order to remove an excess of PVP and impurities after reaction. Silver nanoparticles were stirred and re-dispersed in ultrasonic bath for 10 min, at 35° C. Suspensions from all bottles were mixed and filtered through 1.0 μm Whatman nylon syringe filter. Silver nanoparticles were then centrifuged at 10,000×g for 35 minutes. Resultant, orange clear supernatant was discarded, and silver cake was re-dispersed in 30 ml of ethanol in ultrasonic bath for 10 minutes at 35° C.

Nanoparticles dispersion was transferred to 100 ml round-bottom flask containing 6.0 ml of DI water (first solvent), and gently shaken. Suspension was placed in rotary evaporator (120 RPM), at water bath temperature of 40° C., and lowered pressure of 100 mbar (10 kPa) for 30 minutes. The resultant highly concentrated silver nanoparticles dispersion in DI water (first solvent) was placed in ultrasonic bath for 5 minutes and filtered through 1.0 μm nylon syringe filter to a clean PP container (Nalgene). Suspension was stored in refrigerator at 4° C.

Directly before using, the ink was placed in ultrasonic bath for 2 minutes. Optionally, it can be filtered by using 1.0 μm PA nylon syringe filter.

### Ink Comparative Example 5

Stage C. Separation and Purification of Silver Nanoparticles

The resulting dispersion was equally divided into four 500 ml Nalgene PPCO centrifuge bottles. The procedure of washing the residuals from the reaction flask was then carried out. To the reaction flask from which the liquid was poured out, 50 ml of ethylene glycol was added and shaken. Subsequently, this liquid was poured equally into the same four Nalgene PPCO centrifuge bottles, in which there was a dispersion of nanoparticles.

Then, mixture containing 175 ml of acetone and 80 ml of ethylene glycol was added to each bottle and shaken up well to form rusty-brown precipitate suspensions. If precipitation did not proceed well, color of solution was still dark green. In that case, small volumes (single milliliters) of acetone were added drop by drop to obtain proper precipitate color. Suspensions were centrifuged at 2000×g (RCF) for 15 min. The shiny, reflective silver cakes at bottom of the bottles were obtained. The clear, orange supernatants were discarded. In next step, 30 ml of ethanol was added to each bottle in order to remove an excess of PVP and impurities after reaction. Silver nanoparticles were stirred and re-dispersed in ultrasonic bath for 10 min, at 35° C. Suspensions from all bottles were mixed and filtered through 1.0 μm Whatman nylon syringe filter. Silver nanoparticles were then centrifuged at 11,000×g for 35 minutes. Resultant, orange clear supernatant was discarded, and silver cake was dried in an oven at 40° C. for 12 hours.

Dried silver nanoparticle powder 3.4 g was re-dispersed in 6.6 g of methanol in an ultrasonic bath for 1 hour at 35° C. to obtain a conductive ink composition of 34 wt %. The resultant AgNP methanol ink composition filtered through 1.0 μm nylon syringe filter to a clean PP container (Nalgene).

### Ink Comparative Example 6

Ink Comparative Example 6 differs from Ink Comparative Example 5, in that silver nanoparticles are re-dispersed in ethanol instead of methanol.

### Ink Comparative Example 7

Ink Comparative Example 7 differs from Ink Comparative Example 5, in that silver nanoparticles are re-dispersed in 1-propanol instead of methanol.

### Ink Comparative Example 8

Ink Comparative Example 8 differs from Ink Comparative Example 5, in that silver nanoparticles are re-dispersed in 2-propanol instead of methanol.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the claimed subject matter are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A conductive ink composition, comprising:
metallic nanoparticles;
a first non-aqueous polar protic solvent having a first boiling point of at least 110° C. and a first viscosity of at least 10 cP at 25° C.; and
a second non-aqueous polar protic solvent having a second boiling point of at least 200° C. and a second viscosity of at least 100 cP at 25° C.;
wherein the conductive ink composition contains the metallic nanoparticles in a range of 10 wt % to 75 wt %;
the concentration of the second non-aqueous polar protic solvent in the conductive ink composition is 11.0% by volume or greater; and
a concentration, in aggregate, of water, methanol, ethanol, 1-propanol, and 2-propanol, in the conductive ink composition does not exceed 10.0% by volume.

2-8. (canceled)

9. The conductive ink composition of claim 1, wherein a concentration, in aggregate, of solvents other than the first non-aqueous polar protic solvent and the second non-aqueous polar protic solvent, in the conductive ink composition does not exceed 10.0% by volume.

10-15. (canceled)

16. A conductive ink composition, comprising:
silver nanoparticles;
a first non-aqueous polar protic solvent having two hydroxyl groups; and
a second non-aqueous polar protic solvent having three hydroxyl groups;
wherein the concentration of the second non-aqueous polar protic solvent in the conductive ink composition is 11.0% by volume or greater;
polyvinylpyrrolidone is present on the metallic silver nanoparticle surfaces; and
a concentration, in aggregate, of water, methanol, ethanol, 1-propanol, and 2-propanol, in the conductive ink composition does not exceed 10.0% by volume.
